(19) United States
(12) Patent Application Publication
(10) Pub. No.: US 2012/0248646 A1
(43) Pub. Date: Oct. 4, 2012

(54) Method for Making A Soft Thin Mat

(76) Inventors: Frank Yang, Homei (TW); Henry Yang, Homei (TW)

(21) Appl. No.: 13/074,065

(22) Filed: Mar. 29, 2011

(51) Int. Cl. B27N 3/10; B29C 45/14

(52) U.S. Cl. 264/132; 264/257

(57) ABSTRACT

A method for making a mat includes preparing a primary material and a secondary material, mixing the primary material and the secondary material, binding the primary material and the secondary material, thermosetting the primary material and the secondary material to form a molding material of a soft thin substrate layer, combining a cloth surface layer and a waterproof film to form a combination, placing the combination of the cloth surface layer and the waterproof film in a mold, filling the molding material of the soft thin substrate layer into the mold, and injection molding the molding material in the mold to combine the molding material with the combination of the cloth surface layer and the waterproof film so as to form a mat which comprises the soft thin substrate layer, the cloth surface layer and the waterproof film.

### BACKGROUND OF THE INVENTION

1. Field of the Invention

The present invention relates to a method and, more particularly, to a method for making a soft thin mat.

2. Description of the Related Art

A conventional mat 20 in accordance with the prior art shown in FIG. 6 comprises a rubber foam layer 21 and a hard surface layer 22 combined with the rubber foam layer 21. However, the hard surface layer 22 is combined with the rubber foam layer 21 by an adhesive so that the hard surface layer 22 is easily stripped from the rubber foam layer 21 during a long-term utilization, thereby wearing the mat 20. In addition, the rubber foam layer 21 has a poor adhesive force and cannot provide an anti-slip function to the mat 20 so that when the mat 20 is attached to the surface of an object, the mat 20 easily slips on the surface of the object. Further, the mat cannot be recycled when being worn out or broken during a long-term utilization so that the mat easily pollutes the environment. Further, the rubber foam layer 21 has to be treated by a vulcanized process before it is worked so that the mat 20 easily produces acrid or pungent smell to the user.

### BRIEF SUMMARY OF THE INVENTION

In accordance with the present invention, there is provided a method for making a mat, comprising a first step of preparing a primary material and a secondary material, a second step of mixing the primary material and the secondary material, a third step of binding the primary material and the secondary material, a fourth step of thermosetting the primary material and the secondary material to form a molding material of a soft thin substrate layer, a fifth step of preparing and combining a cloth surface layer and a waterproof film to form a combination of the cloth surface layer and the waterproof film, a sixth step of placing the combination of the cloth surface layer and the waterproof film in a mold, a seventh step of filling the molding material of the soft thin substrate layer into the mold, and an eighth step of injection molding the molding material of the soft thin substrate layer in the mold to combine the molding material of the soft thin substrate layer with the combination of the cloth surface layer and the waterproof film so as to form a product of a mat which comprises the soft thin substrate layer, the cloth surface layer and the waterproof film.

According to the primary advantage of the present invention, the waterproof film permeates through the soft thin substrate layer during the injection molding process so that the cloth surface layer is combined with the soft thin substrate layer solidly and closely to enhance the structural strength and lifetime of the mat.

According to another advantage of the present invention, the soft thin substrate layer has a better adhesive force so that the soft thin substrate layer is attached to the surface of an object exactly and stably to provide an anti-slip function to the mat.

According to a further advantage of the present invention, the cloth surface layer has a smooth face to provide wiping and cleaning functions.

According to a further advantage of the present invention, the mat can be recycled when being worn out or broken during a long-term utilization to prevent from polluting the environment.

According to a further advantage of the present invention, the cloth surface layer has a decorative face to enhance the aesthetic quality of the mat.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a mat in accordance with the preferred embodiment of the present invention.

FIG. 2 is a partially side cross-sectional view of the mat as shown in FIG. 1.

FIG. 3 is a flow chart of a method for making a mat in accordance with the preferred embodiment of the present invention.

FIG. 4 is a perspective view of a mat in accordance with another preferred embodiment of the present invention.

FIG. 5 is a perspective view of a mat in accordance with another preferred embodiment of the present invention.

FIG. 6 is a perspective view of a conventional mat in accordance with the prior art.

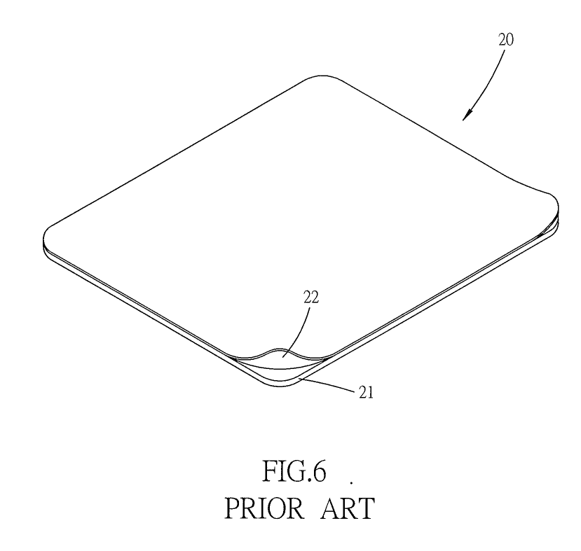

### DETAILED DESCRIPTION OF THE INVENTION

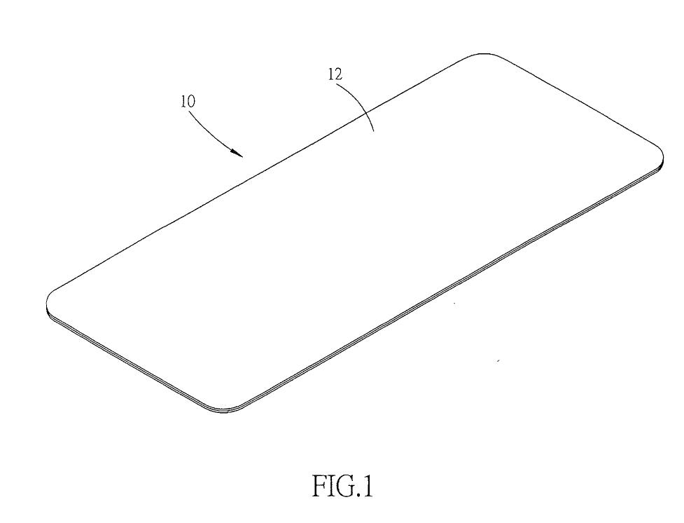

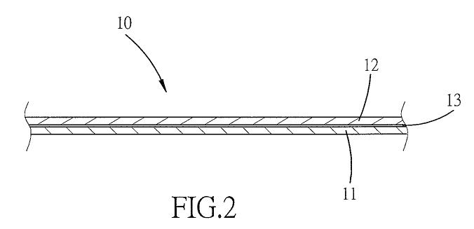

Referring to the drawings and initially to FIGS. 1 and 2, a mat 10 in accordance with the preferred embodiment of the present invention comprises a soft thin substrate layer 11, a waterproof film 13 having a first side combined with the soft thin substrate layer 11, and a cloth surface layer 12 combined with a second side of the waterproof film 13.

The soft thin substrate layer 11 is made of a thermoplastic polymer. Preferably, the soft thin substrate layer 11 is made of polyurethane (PU). The soft thin substrate layer 11 has various colors by dyeing. Alternatively, the soft thin substrate layer 11 is transparent. Preferably, the soft thin substrate layer 11 has a thickness smaller than 1 mm. The waterproof film 13 is made of PU or thermoplastic polyurethane elastomer (TPU). The waterproof film 13 is sandwiched between the soft thin substrate layer 11 and the cloth surface layer 12. The cloth surface layer 12 is made of a micro-fiber. Preferably, the cloth surface layer 12 has a thickness of about 0.3 mm.

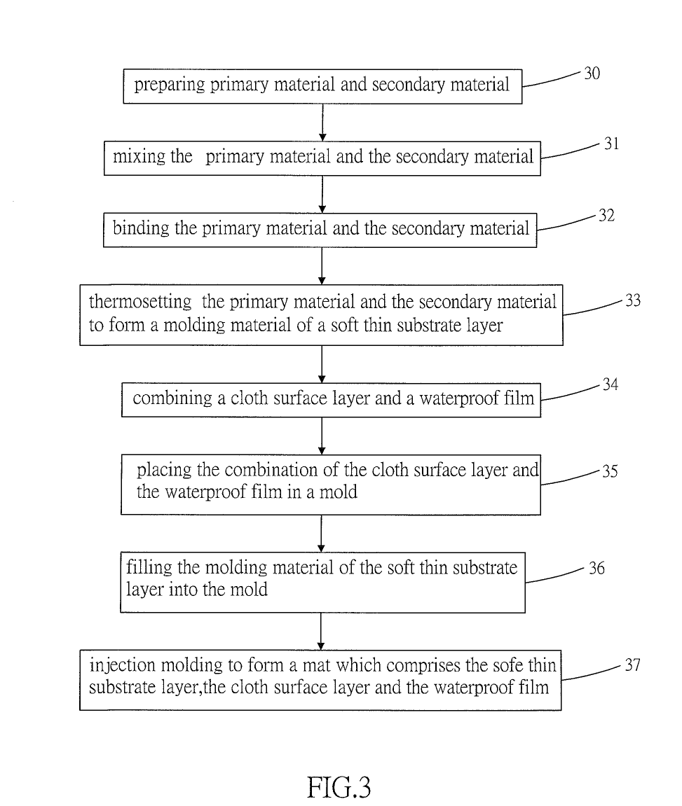

Referring to FIGS. 1-3, a method for making a mat in accordance with the preferred embodiment of the present invention comprises a first step 30 of preparing a primary material and a secondary material, a second step 31 of mixing the primary material and the secondary material, a third step 32 of binding the primary material and the secondary material, a fourth step 33 of thermosetting the primary material and the secondary material to form a molding material of a soft thin substrate layer 11, a fifth step 34 of preparing and combining a cloth surface layer 12 and a waterproof film 13 to form a combination of the cloth surface layer 12 and the waterproof film 13, a sixth step 35 of placing the combination of the cloth surface layer 12 and the waterproof film 13 in a mold, a seventh step 36 of filling the molding material of the soft thin substrate layer 11 into the mold, and an eighth step 37 of injection molding the molding material of the soft thin substrate layer 11 in the mold to combine the molding material of the soft thin substrate layer 11 with the combination of the cloth surface layer 12 and the waterproof film 13 so as to form a product of a mat 10 which comprises the soft thin substrate layer 11, the cloth surface layer 12 and the waterproof film 13.

In the first step 30 of preparing a primary material and a secondary material, the primary material is made of PU, and the secondary material is made of a composite material that hardens or solidifies the primary material. In the first step 30 of preparing a primary material and a secondary material, the primary material has various colors by dyeing. Alternatively, the primary material is transparent. In the second step 31 of mixing the primary material and the secondary material, both of the primary material and the secondary material are disposed at a liquid state. In the third step 32 of binding the primary material and the secondary material, the primary material and the secondary material bind together during a bridging reaction. In the sixth step 35 of placing the combination of the cloth surface layer 12 and the waterproof film 13 in a mold, the mold is disposed at a vacuum condition and includes an upper die and a lower die. In the seventh step 36 of filling the molding material of the soft thin substrate layer 11 into the mold, the molding material of the soft thin substrate layer 11 is poured into the mold at a low pressure.

Accordingly, the waterproof film 13 permeates through the soft thin substrate layer 11 during the injection molding process so that the cloth surface layer 12 is combined with the soft thin substrate layer 11 solidly and closely to enhance the structural strength and lifetime of the mat 10. In addition, the soft thin substrate layer 11 has a better adhesive force so that the soft thin substrate layer 11 is attached to the surface of an object exactly and stably to provide an anti-slip function to the mat 10. Further, the cloth surface layer 12 has a smooth face to provide wiping and cleaning functions. Further, the mat 10 can be recycled when being worn out or broken during a long-term utilization to prevent from polluting the environment.

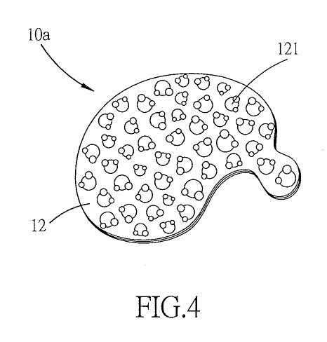

Referring to FIG. 4, the cloth surface layer 12 has a side provided with a decorative face 121 by printing to enhance the aesthetic quality of the mat 10a. Preferably, the decorative face 121 of the cloth surface layer 12 presents various patterns, characters or figures. In addition, the mat 10a is cut to have a different shape to function as a cup mat or a dinner mat.

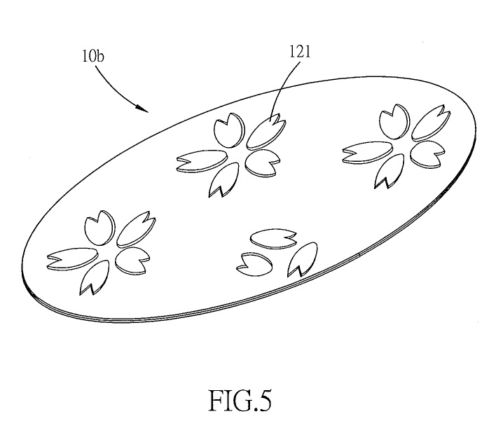

Referring to FIG. 5, the mat 10b has a different shape to function as a mouse mat, an anti-slip mat or other mat.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for making a mat, comprising:
a first step of preparing a primary material and a secondary material;
a second step of mixing the primary material and the secondary material;
a third step of binding the primary material and the secondary material;
a fourth step of thermosetting the primary material and the secondary material to form a molding material of a soft thin substrate layer;
a fifth step of preparing and combining a cloth surface layer and a waterproof film to form a combination of the cloth surface layer and the waterproof film;
a sixth step of placing the combination of the cloth surface layer and the waterproof film in a mold;
a seventh step of filling the molding material of the soft thin substrate layer into the mold; and
an eighth step of injection molding the molding material of the soft thin substrate layer in the mold to combine the molding material of the soft thin substrate layer with the combination of the cloth surface layer and the waterproof film so as to form a product of a mat which comprises the soft thin substrate layer, the cloth surface layer and the waterproof film.

2. The method for making a mat of claim 1, wherein in the first step of preparing a primary material and a secondary material, the primary material is made of polyurethane (PU), and the secondary material is made of a composite material that hardens or solidifies the primary material.

3. The method for making a mat of claim 2, wherein in the first step of preparing a primary material and a secondary material, the primary material has various colors by dyeing.

4. The method for making a mat of claim 2, wherein in the first step of preparing a primary material and a secondary material, the primary material is transparent.

5. The method for making a mat of claim 1, wherein in the second step of mixing the primary material and the secondary material, both of the primary material and the secondary material are disposed at a liquid state.

6. The method for making a mat of claim 1, wherein in the third step of binding the primary material and the secondary material, the primary material and the secondary material bind together during a bridging reaction.

7. The method for making a mat of claim 1, wherein in the sixth step of placing the combination of the cloth surface layer and the waterproof film in a mold, the mold is disposed at a vacuum condition.

8. The method for making a mat of claim 1, wherein in the sixth step of placing the combination of the cloth surface layer and the waterproof film in a mold, the mold includes an upper die and a lower die.

9. The method for making a mat of claim 1, wherein in the seventh step of filling the molding material of the soft thin substrate layer into the mold, the molding material of the soft thin substrate layer is poured into the mold at a low pressure.

10. The method for making a mat of claim 1, wherein the waterproof film is made of PU.

11. The method for making a mat of claim 1, wherein the waterproof film is made of thermoplastic polyurethane elastomer (TPU).

12. The method for making a mat of claim 1, wherein the waterproof film is sandwiched between the soft thin substrate layer and the cloth surface layer.

13. The method for making a mat of claim 1, wherein the soft thin substrate layer has a thickness smaller than 1 mm.

14. The method for making a mat of claim 1, wherein the cloth surface layer is made of a micro-fiber.

15. The method for making a mat of claim 1, wherein the cloth surface layer has a thickness of about 0.3 mm.

16. The method for making a mat of claim 1, wherein the cloth surface layer has a side provided with a decorative face by printing.
